(19) United States
(12) Patent Application Publication
(10) Pub. No.: US 2014/0165965 A1
(43) Pub. Date: Jun. 19, 2014

(54) FUEL SUPPLY SYSTEM WITH ACCUMULATOR

(71) Applicants: Michael R. Teets, Grosse Pointe Park, MI (US); Joseph B. Adams, Northville, MI (US); Thomas A. Sharp, South Lyon, MI (US); Regina M. Cook, Chesterfield, MI (US); Paul J. Fitzgerald, Troy, MI (US); Russell J. Wakeman, Canton, MI (US); John R. Jaye, Northville, MI (US); Glen E. Tallarek, Grosse Pointe Woods, MI (US); Paul J. Luft, Novi, MI (US)

(72) Inventors: Michael R. Teets, Grosse Pointe Park, MI (US); Joseph B. Adams, Northville, MI (US); Thomas A. Sharp, South Lyon, MI (US); Regina M. Cook, Chesterfield, MI (US); Paul J. Fitzgerald, Troy, MI (US); Russell J. Wakeman, Canton, MI (US); John R. Jaye, Northville, MI (US); Glen E. Tallarek, Grosse Pointe Woods, MI (US); Paul J. Luft, Novi, MI (US)

(21) Appl. No.: 13/718,474

(22) Filed: Dec. 18, 2012

(51) Int. Cl. F02M 41/16

(52) U.S. Cl. CPC F02M 41/16
USPC 123/447

(57) ABSTRACT

A fuel supply system with an accumulator that allows for the accumulation of fuel at a pressure greater than the nominal operating pressure of the fuel supply system. The accumulation of fuel allows for less frequent fuel pump operation and therefore a reduction in overall fuel consumption of an engine.

### FIELD

The present disclosure relates to a fuel supply system, and more particularly, to a fuel supply system with an accumulator utilized to increase fuel efficiency.

### BACKGROUND

A typical fuel supply system for an internal combustion engine includes a fuel pump that conveys fuel being stored in a fuel tank through a fuel supply line to a fuel injector on the engine. As the engine operates, the fuel pump is activated to provide a continuous supply of fuel to the engine. However, an engine's fuel consumption varies greatly with its required output. More fuel is required during times of higher engine demand and less fuel during times of lesser engine demand, or during idling. In order to ensure that the engine is always provided with adequate fuel, the fuel pump is typically designed to provide fuel to the engine at the rate required for maximum engine output. Therefore, during times of less-than maximum engine output, the fuel pump delivers excess fuel to the system. It is common for a fuel supply system to include a flow through regulator to ensure that only the required amount of fuel is provided to the engine, and to allow for any excess fuel provided to the fuel supply line to be returned to the fuel tank by means of a fuel return line.

With the fuel pump designed to provide fuel to meet the requirements of the engine when operating at maximum output, electrical energy is consumed wastefully by the pump during times of non-peak engine output. During these non-peak times, the fuel pump is providing excess fuel to the fuel supply system which is then returned to the fuel tank via the flow through regulator and fuel return line. Accordingly, there is a need for improvement in the art.

### SUMMARY

The present disclosure provides a fuel supply system that includes an accumulator disposed in fluid communication with the fuel pump and the engine. The accumulator allows for fuel to be accumulated within the fuel supply system when the fuel pump is activated. Excess fuel provided by the fuel pump during times of non-peak engine output is stored within the accumulator and later utilized by the engine rather then being returned to the tank through the flow through regulator and return line. Allowing for the accumulation of fuel within the accumulator rather than returning the excess fuel to the tank permits the fuel pump to be operated less frequently then in a typical fuel supply system. This reduces the expenditure of electrical power to operate the fuel pump, and in-turn increases the fuel economy of the engine by requiring less electrical current to be drawn from a vehicle's electrical system.

Thus, a fuel supply system that reduces the wasted electrical energy consumed by the fuel pump when the engine is operating at less-than maximum output is provided.

Further areas of applicability of the present disclosure will become apparent from the detailed description provided hereinafter. It should be understood that the detailed description, including disclosed embodiments and drawings, are mere exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a schematic diagram showing a general overview of an automotive fuel supply apparatus according to the present invention.

### DETAILED DESCRIPTION

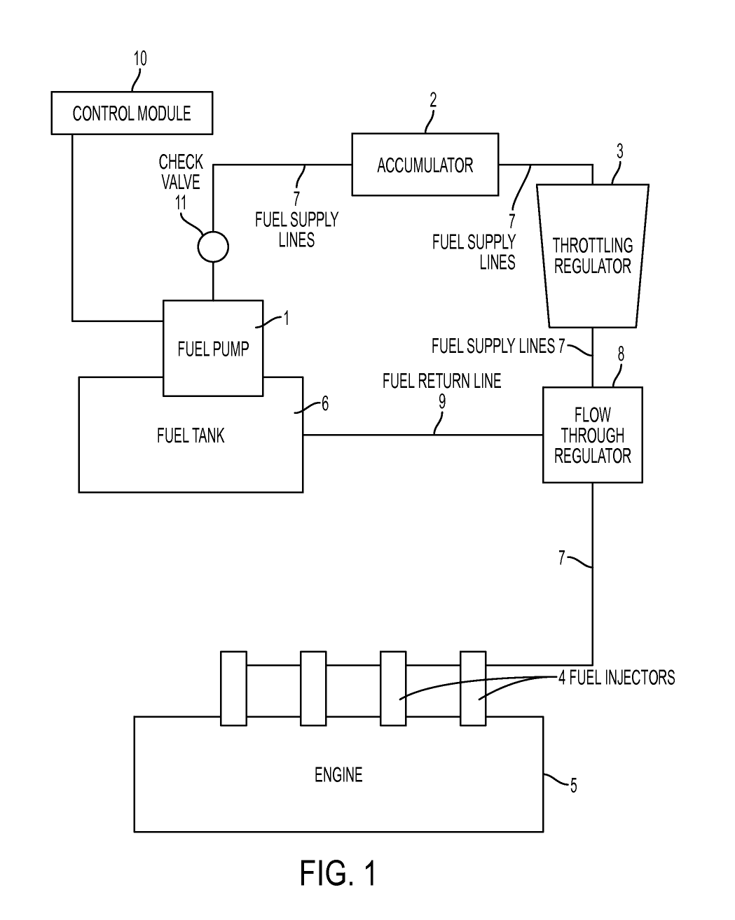

FIG. 1 is a schematic representation of an exemplary fuel supply system according to the principles of the present disclosure. Embodiments of the invention disclosed herein minimize wasted electrical energy consumed by the fuel pump when the engine is operating at less-than maximum output. The fuel supply system includes a fuel pump 1 providing fuel to the fuel supply system from a fuel tank 6. The fuel pump is in fluid communication with an accumulator 2, a throttling regulator 3, a flow through regulator 8, and at least one fuel injector 4 on an engine 5. In one embodiment, the fluid communication within the fuel supply system is provided by fuel supply lines 7.

The fuel pump 1 is equipped with an electrical motor that draws current from the vehicle's electrical system in order to operate. Typically, a battery for the storage of electrical energy and an alternator for converting mechanical energy supplied by the engine into electrical energy are also provided within the vehicle's electrical system. A reduction in the fuel pump's frequency of operation leads to a reduction in current draw from the electrical system. This in-turn requires the alternator to convert less mechanical energy generated by the engine into electrical energy.

The accumulator 2 may be any type of accumulator, including, but not limited to, a compressed gas accumulator, a spring type accumulator, or a metal bellows type accumulator. The accumulator 2 is configured to fill with fuel after the pressure within the fuel supply line 7 exceeds a nominal operating pressure of the fuel supply system. The nominal operating pressure of the fuel supply system is the pressure required to ensure that adequate fuel is supplied to the fuel injectors 4 so that the engine 5 operates efficiently. For example, if the nominal operating pressure is 57 p.s.i., the accumulator 2 of the present system will start to fill at pressures exceeding 57 p.s.i.

The throttling regulator 3 allows for a substantially constant supply of fuel to the engine 5 at approximately the nominal operating pressure regardless of pressure variations above the nominal operating pressure at the inlet of the throttling regulator 3. The inlet of the throttling regulator 3 is in fluid communication with the accumulator 2, and the outlet of the throttling regulator 3 is in fluid communication with the fuel injectors 4 of the engine 5. The throttling regulator 3 is preferably positioned between the accumulator 2 and fuel injectors 4 allowing for higher fuel pressures to be present between the fuel pump 1 and the inlet of the throttling regulator 3, while maintaining a supply of fuel to the fuel injectors 4 of the engine 5 at approximately the nominal operating pressure. With this configuration, fuel is accumulated within the accumulator 2 at a pressure greater than the nominal operating pressure, while fuel supplied to the engine 5 is at approximately the nominal operating pressure.

The flow through regulator 8 protects the system from overpressure events, and therefore is set to relieve pressure within the fuel supply system at a threshold higher than the nominal operating pressure. The flow through regulator 8 is preferably positioned between the throttling regulator 3 and the fuel injectors 4 on the engine 5. Excess fuel is returned only during overpressure events (e,g, hot soaks) by the flow through regulator 8 to the fuel tank 6 through a fuel return line 9.

A check valve 11 is provided so as to prevent fuel supplied to the fuel supply system from returning to the fuel tank 6 through the fuel pump 1 when the fuel pump 1 is not in operation. The check valve 11 also allows the fuel supply system to remain pressurized when the fuel pump 1 is not activated.

During operation, a control module 10 monitors and controls the fuel pump 1, and can activate and deactivate the fuel pump 1 so as to maintain a pressure in the accumulator higher than the nominal operating pressure, to insure a constant supply of fuel to the engine 5. In one embodiment of the present invention, the control module 10 monitors a current draw from the electrical motor of the fuel pump 1. When the current draw reaches a predetermined value, the control module 10 deactivates the fuel pump 1. The predetermined current draw value at which the fuel pump 1 is deactivated can be fixed or variable. For example, the predetermined pump current draw value can be calculated using an established characteristic curve of pump motor current draw in relation to accumulator pressure.

In another embodiment of the present invention, a pressure sensor within the fuel supply system provides pressure data to the control module 10. When the pressure reaches a predetermined value, the control module 10 deactivates the fuel pump 1. In yet another embodiment of the present invention, the fuel pump 1 is supplied with a pressure switch. The pressure switch deactivates the fuel pump 1 once the pressure within the fuel supply system reaches a predetermined value.

In yet another embodiment of the present invention, the control module 10 calculates the time it takes the pump 1 to fill the accumulator 2 with fuel from its current state of fill, and activates the pump for this predetermined time. The control module 10 deactivates the fuel pump 1 once this predetermined time has elapsed since the fuel pump 1 was last activated. This predetermined time can be a function of the calculated or measured amount of fuel consumed by the engine since the accumulator was last filled, to minimize the amount of time that the pump is activated. Specifically, the level of engine demand can be measured or calculated by the control module 10. The control module 10 can then calculate the amount of fuel being consumed in comparison to the amount of fuel being stored in the accumulator 2, and adjust the predetermined pump activation time accordingly. For example, when the engine is idling, the predetermined pump activation time is relatively short in comparison to times of high engine demand.

In yet another embodiment of the present invention, the control module 10 monitors the engine fueling correction required to maintain a desired exhaust gas oxygen output of the vehicle while in operation. When the correction required to maintain a desired exhaust gas oxygen output reaches a predetermined value, the control module 10 deactivates the fuel pump 1.

While the fuel pump is deactivated, the accumulator 2 is pressurized with fuel at a pressure greater than that required for engine operation, allowing the accumulator 2 to continue to supply adequate fuel to the engine 5. The fuel pump 1 is once again activated when fuel stored within the accumulator 2 has decreased below a predetermined volume.

In one embodiment of the present invention, a pressure sensor within the fuel supply system provides pressure data to the control module 10. When the pressure falls to a predetermined value, the control module 10 reactivates the fuel pump 1. In another embodiment of the present invention, the fuel pump 1 is supplied with a pressure switch. The pressure switch reactivates the fuel pump 1 once the pressure within the fuel supply system falls to a predetermined value. The pressure at which the pump is activated may be a constant value, or may be altered in relation to engine demand and the rate of fuel consumption.

In yet another embodiment of the present invention, the accumulator 2 is equipped with a volume sensor that provides data to the control module 10. When the accumulator volume falls to a predetermined value, the control module 10 reactivates the fuel pump 1. In yet another embodiment of the present invention, the control module 10 monitors the number and duration of fuel injector pulses to calculate the amount of fuel used by the engine since the accumulator 2 was last filled with fuel. When the fuel output from the accumulator reaches a predetermined amount, the control module 10 reactivates the fuel pump 1.

In addition, the control module 10 activates the fuel pump 1 when the engine 5 is in a reverse power state. A reverse power state is a state when the electrical energy needed to operate the fuel pump 1 can be obtained from the vehicle's electrical system with little or no additional fuel energy from the engine 5 being expended, or conditions where the vehicle's inertia reverses torque in the drivetrain to motor the engine with little or no consumption of fuel energy. Reverse power states include, but are not limited to, times when the vehicle is decelerating, coasting, or descending a hill. By operating the fuel pump 1 when the engine 5 is in a reverse power state, the accumulator 2 can be filled with fuel when less fuel energy is expended by the engine 5, thus leading to a further increase in fuel efficiency.

Depending on the requirements and physical dimensions of the components of the fuel supply system, the components can be arranged in any fashion that allows for adequate operation of the system. As such, the fuel pump 1, the accumulator 2, the throttling regulator 3, and the flow through regulator 8 can be contained within the fuel tank 6, or located in different parts of the fuel supply system.

The disclosed fuel supply system therefore allows for adequate fuel to be supplied to the engine 5, while conserving energy and reducing fuel consumption. The accumulator 2 allows for fuel to be accumulated within the fuel supply system so that the fuel pump 1 is operated less frequently. Because the accumulator 2 is configured to fill with fuel after the pressure within the fuel supply line exceeds a nominal operating pressure, fuel is provided to the engine more quickly upon initial startup, allowing for faster and more reliable engine starts. In addition, operating the fuel pump 1 to fill the accumulator 2 when the engine 5 is in a reverse power state further increases fuel efficiency.

What is claimed is:

1. A fuel supply system comprising:
a fuel pump,
a throttling regulator in fluid communication with the fuel pump,
at least one fuel injector in fluid communication with the throttling regulator, and
an accumulator disposed between the fuel pump and the throttling regulator, the accumulator configured to accumulate fuel at a pressure greater than a nominal operating pressure set by the throttling regulator.

2. The fuel supply system according to claim 1, further comprising a flow though regulator disposed between the throttling regulator and the at least one fuel injector.

3. The fuel supply system according to claim 1, further comprising a control module connected to the fuel pump for monitoring and controlling operation of the fuel pump.

4. The fuel supply system according to claim 3, wherein the control module monitors a current draw of the fuel pump to control operation of the fuel pump.

5. The fuel supply system according to claim 4, wherein the current draw values at which the fuel pump is activated and deactivated vary in relation to the accumulator pressure.

6. The fuel supply system according to claim 3, further comprising a pressure sensor connected to the control module, wherein the control module monitors a pressure within the fuel supply system to control operation of the fuel pump.

7. The fuel supply system according to claim 6, wherein the pressure values at which the pump is activated and deactivated vary in relation to engine fuel consumption.

8. The fuel supply system according to claim 3, further comprising a pressure switch connected to the fuel pump, wherein the pressure switch controls operation of the fuel pump.

9. The fuel supply system according to claim 3, further comprising a volume sensor connected to the accumulator and control module, wherein the control module monitors the volume of fuel within the accumulator to control operation of the fuel pump.

10. The fuel supply system according to claim 3, wherein the control module calculates the amount of fuel within the accumulator and the required pump activation time to fill the accumulator in its current state to control the operation of the fuel pump.

11. The fuel supply system according to claim 3, wherein the control module monitors engine fueling correction required to maintain a desired exhaust gas oxygen output of the vehicle to control operation of the fuel pump.

12. The fuel supply system according to claim 3, wherein the control module monitors a number and duration of fuel injector pulses to control operation of the fuel pump.

13. The fuel supply system according to claim 3, wherein the control module activates the fuel pump preferably during a reverse power state.

14. The fuel supply system according to claim 1, wherein the accumulator is configured to fill only after the fuel pressure exceeds the nominal operating pressure of the fuel supply system.

15. A method for controlling a fuel supply system, the method comprising:
monitoring a state and operating characteristics of a fuel pump, and
activating the fuel pump to pressurize an accumulator to a pressure above a nominal operating pressure of the fuel supply system.

16. The method according to claim 13, wherein the fuel pump is activated during a reverse power state.

17. The method according to claim 13, wherein a current draw of the fuel pump is monitored to control operation of the fuel pump.

18. The method according to claim 13, wherein the current draw values at which the fuel pump is activated and deactivated vary in relation to the accumulator pressure.

19. The method according to claim 13, wherein a fuel output pressure of the fuel pump is monitored to control operation of the fuel pump.

20. The method according to claim 19, wherein the fuel output pressure values at which the pump is activated and deactivated vary in relation to engine fuel consumption.
